(19) United States
(12) Patent Application Publication
(10) Pub. No.: US 2003/0134186 A1
(43) Pub. Date: Jul. 17, 2003

(54) Non-aqueous electrolyte secondary battery

(76) Inventor: Takahiro Shizuki, Kyoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/338,905

(22) Filed: Jan. 9, 2003

(30) Foreign Application Priority Data
Jan. 16, 2002 (JP) 2002-007592

(51) Int. Cl. H01M 2/02; H01M 4/66; H01M 4/50

(52) U.S. Cl. 429/94; 429/175; 429/245; 429/223; 429/231.1

(57) ABSTRACT

A non-aqueous electrolyte secondary battery of the invention comprises a power generating element in which a strip negative electrode having negative mixture layers on a negative substrate and a strip positive electrode having positive mixture layers on a positive substrate are wound in a flat, elliptic cylindrical shape with a separator therebetween and in which one edge portion of the negative substrate and one edge portion of the positive substrate protrude from the separator to the opposite direction from each other. When the dimensions of said power generating element hold the relations of Y/X≧2.5 and Y/Z≧0.6, where X is the length of minor axis, Y is the length of major axis and Z is the height of said power generating element held in a cell case, the present invention provides the non-aqueous electrolyte secondary battery having large discharge capacity and excellent discharge characteristics.

### BACKGROUND OF THE INVENTION

1. Field of the Invention

This invention relates to a non-aqueous electrolyte secondary battery having a wound type power generating element which is formed into an elliptic cylindrical shape.

2. Description of the Prior Art

The demands for the non-aqueous electrolyte secondary batteries of lighter weight with a high capacity density are increasing in the field of portable devices such as cell phones, PCs and the like. In addition, the non-aqueous electrolyte secondary batteries with a large discharge capacity in the range of 3 Ah to 200 Ah are attracting attention in the field of such appliances as power storage batteries and electric vehicle batteries. Recently, development of these batteries has been briskly conducted.

In such a non-aqueous electrolyte secondary battery of large capacity type, a power generating element is usually configured by winding strips of positive and negative electrodes with a separator therebetween into a flat, elliptic cylindrical shape (with wound electrode group). This makes strip electrodes extremely long, and sufficiently large currents of more than score amperes are repeatedly charged and discharged.

Therefore, through a current collecting method applied to the conventional compact batteries used for portable devices, in which a lead is welded at the end portion of a strip electrode plate for current collection, it was impossible to obtain sufficient battery properties because of such reasons as an increase in voltage drop due to substrate resistance and so on.

In non-aqueous electrolyte secondary batteries of large capacity type, hence, various devices have been made to improve the way to collect electric current.

FIG. 1 shows such a conventional configuration example of a non-aqueous electrolyte secondary battery of large capacity type.

The non-aqueous electrolyte secondary battery, as shown in FIG. 1, has a flat, wound type power generating element. The power generating element is configured by flatly winding a strip negative electrode 3 having negative mixture layers 10 on a negative substrate and a strip positive electrode 2 having positive mixture layers 8 on a positive substrate with a separator 4 therebetween. One edge portion of the negative substrate, that is, a non-applied portion of negative mixture in negative substrate 9, protrudes from lower end of the separator 4, and one edge portion of the positive substrate, that is, a non-applied portion of positive mixture in positive substrate 7, protrudes from upper end of the separator 4.

A positive collector 5 is connected with the non-applied portion of positive mixture in positive substrate 7, the upper portion of the wound type power generating element, and a negative collector 6 is connected with the non-applied portion of negative mixture in negative substrate 9, the lower portion of the wound type power generating element, by ultrasonic welding so as to perform current collection.

According to this collecting method, in a linear portion other than a semicircular area of the wound type power generating element of an elliptic cylindrical shape, current collection can be performed in a wide rage on one edge portion of substrate (a non-applied portion of mixture layer). This reduces voltage drop due to substrate resistance and makes charge/discharge of sufficiently large current (high rate) possible.

However, when the above non-aqueous electrolyte secondary battery of large discharge capacity type is tried to be utilized in a wide variety of services, due to the restrictions involving a battery storage box, the size/dimension of setting place, or the number of batteries to be stored, various limitations occur regarding the shape of the battery. Therefore, it is difficult for the battery of only one shape to cope with such restrictions, and hence there arose a necessity to produce batteries which satisfy the requirements for individual application.

In addition, a change in the shape of battery necessarily causes a change in the shape of the power generating element to be housed in a cell case. In this case, if the cross section of the flatly wound power generating element is an elliptic shape, for example, it is possible to secure a sufficient linear portion to which a collector is connected. However, the closer the shape of the cross section gets to a circular form, the narrower the linear portion necessary for current collection becomes, and consequently a portion to which a lead for current collection is to be welded becomes smaller. This often results in an increase in battery internal resistance, or a rise in temperature in the collector portion at large current discharge.

Furthermore, in the case of a large scale charging/discharging, if the height of the power generating element is too high, the distance from a collector portion to the other end portion of electrode gets longer so that the current density distribution in electrode becomes non-uniform. This has a negative effect on the high rate discharge characteristics of battery.

Especially, in a non-aqueous electrolyte secondary battery of large capacity type having a discharge capacity of 3 Ah or more, for the purpose of reducing the total weight of the battery and securing a large energy density, various efforts are being made including the reduction in the thicknesses of the electrode substrates and the weights of the collectors or other components. When the thicknesses of the electrode substrates are reduced, however, the resistance in the cross-sectional area per unit width increases, and voltage at the above mentioned high rate discharge drops substantially. Therefore, there arise problems of not only a reduction in discharge capacity but also a rise in temperature at the collector portions.

### SUMMARY OF THE INVENTION

It is an object of the present invention to determine the shape of the power generating element contained in the cell case, so that the above mentioned problems are solved and a non-aqueous electrolyte secondary battery of large capacity having excellent discharge characteristics are provided.

The non-aqueous electrolyte secondary battery of the invention comprises: a strip negative electrode having negative mixture layers on a negative substrate; a strip positive electrode having positive mixture layers on a positive substrate; a separator; and a wound type power generating element in which the strip negative and positive electrodes are flatly wound with the separator therebetween, and in which one edge portion of the negative substrate and one edge portion of the positive substrate protrude from the separator to the opposite direction from each other; wherein the dimensions of the wound type power generating element satisfy the relations of Y/X≧2.5 and Y/Z≧0.6, where X is the length of minor axis (the length in the direction of minor axis of elliptical section), Y is the length of major axis (the length in the major axis direction) and Z is the height (the length in the winding axis direction) of the wound type power generating element held in a cell case.

According to the invention, a non-aqueous electrolyte secondary battery which is excellent in high rate discharge characteristics can be obtained.

The non-aqueous electrolyte secondary battery of the invention has a capacity of 3 Ah or more (at the one hour rate discharge) and is particularly effective in improving high rate discharge characteristics.

### BRIEF DESCRIPTION OF THE DRAWINGS

FIG. 1 is a perspective view showing an example of the configuration of a non-aqueous electrolyte secondary battery of large capacity type.

FIG. 2 is a perspective view showing the external appearance of a wound type power generating element.

FIG. 3 is a diagram showing discharge curves at 1C discharge and 3C discharge in a battery A (changes in voltage with the discharge capacity).

FIG. 4 is a diagram showing discharge curves at 1C discharge and 3C discharge in a battery E.

### DESCRIPTION OF THE PREFERRED EMBODIMENT

Hereinafter, preferred embodiments of the invention will be described to represent further the details of the invention.

The non-aqueous electrolyte secondary battery of the invention comprises: a strip negative electrode having negative mixture layers on a negative substrate; a strip positive electrode having positive mixture layers on a positive substrate; a separator; and a flatly wound type power generating element in which the strip negative and positive electrodes are flatly wound with the separator therebetween, and in which one edge portion of the negative substrate and one edge portion of the positive substrate protrude from the separator to the opposite direction from each other; wherein the dimensions of said flatly wound type power generating element satisfy the relations of Y/X≧2.5 and Y/Z≧0.6, where X is the length of minor axis (the length in the direction of minor axis of elliptical section), Y is the length of major axis (the length in the major axis direction) and Z is the height (the length in the winding axis direction) of said flatly wound type power generating element held in a cell case.

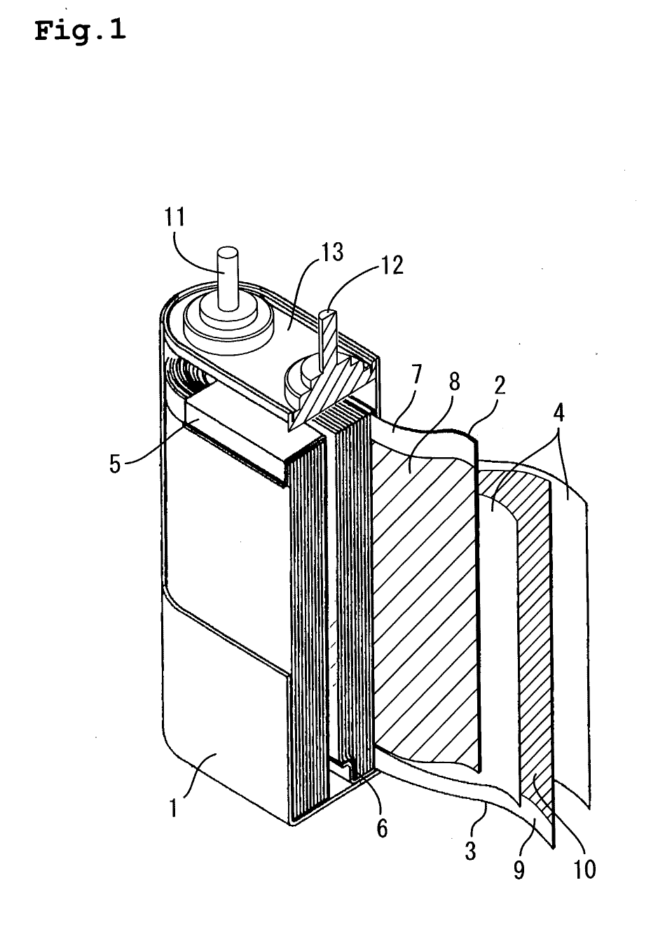

The non-aqueous electrolyte secondary battery of the invention comprises, much the same manner as shown in FIG. 1, a flatly wound type power generating element which is configured so that strip negative and positive electrodes are flatly wound with a separator therebetween and in which one edge portion of a negative substrate protrudes from lower end of the separator and one edge portion of a positive substrate protrudes from upper end of the separator. A positive collector is welded on the edge portion in the positive substrate, the upper portion of the flatly wound type power generating element, and a negative collector is welded on the edge portion in the negative substrate, the lower portion of the flatly wound type power generating element.

In a non-aqueous electrolyte secondary battery having this configuration, the flatly wound type power generating element whose dimensions are made to satisfy the relations expressed by the above expressions can restrain voltage drop due to polarization at high rate discharge, so that excellent high rate charge/discharge characteristics can be provided. Therefore, by adopting appropriate dimensions of the wound type power generating element using such a current collecting method, this invention can reduce voltage drop due to substrate resistance and allows extremely large current to be charged and discharged.

The present invention is especially effective in the non-aqueous electrolyte secondary battery of large capacity type with a discharge capacity of 3 Ah or more (at the one hour rate discharge) and with thick substrates. It can provide the non-aqueous electrolyte secondary battery having excellent high rate charge/discharge characteristics.

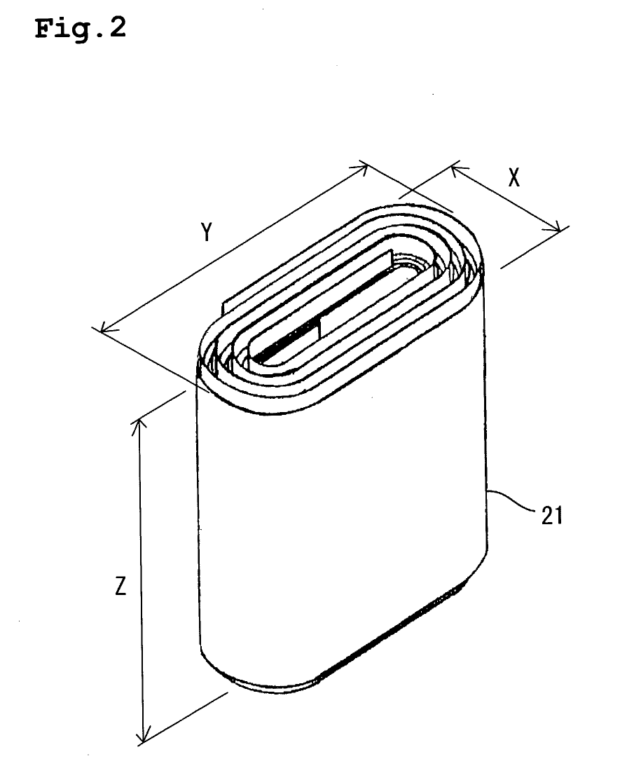

FIG. 2 shows the external appearance of a wound type power generating element in the shape of flat, elliptic cross section which is used for the non-aqueous electrolyte secondary battery of the invention.

In a wound type power generating element housed in a cell case, as described later in the embodiment section, batteries are so prepared as to have different dimensions in the length of minor axis, X, the length of major axis, Y and the height, Z, and then their discharge characteristics are compared. When the dimensions of X, Y, and Z satisfy the relations of Y/X≧2.5 and Y/Z≧0.6, a non-aqueous electrolyte secondary battery can have large discharge capacity even at high rate discharge.

When the dimension of a wound type power generating element is set to Y/X≧2.5, the linear portion of non-applied portion of mixture in substrate, which is used for current collection, is allowed to be sufficiently long. And when the cross-sectional area of a collector is made large, the resistance of the collector can be reduced, so that voltage drop at high rate discharge can be restrained.

In addition, with Y/Z≧0.6, which means that the height of a power generating element, Z, is smaller than the length of major axis, Y, the distance from a collector to the end of a power generating element becomes short, so that the current density in the electrode becomes uniform even at high rate discharge. As a result, a large amount of discharge capacity can be obtained.

### Embodiment

A battery of the invention is a non-aqueous electrolyte secondary battery comprising a strip positive electrode formed by a positive active material, for example, lithium manganese, a strip negative electrode formed by a negative active material such as carbon materials doping/undoping lithium ion, a separator, and a non-aqueous electrolyte.

In the present invention, there is no limitation on the kinds of positive and negative active materials. Positive active materials other than lithium manganese or negative active materials other than carbon materials have also an effect to improve high rate discharge characteristics.

The battery of the invention is primarily used when particularly high power is required, so that it is desirable to apply a positive active material which is effective to ensure high power as well as the devices of the current collecting method and the shape of power generating element. Lithium manganese holds noble discharge voltage in comparison with lithium cobaltate or lithium nickelate; therefore, it is preferable as a positive active material for high power batteries to be used in the invention.

The lithium manganese of the invention is expressed as a skeleton structure, Li_{z}MnO_{y}, and more specifically, LiMnO₂, Li₂MnO₃, LiMn₂O₄, LiMn₂O₃ and so on. Among them, those expressed as LiMn₂O₄ and LiMn₂O₃ are desirable. In these fundamental skeleton structures, when part of Mn component is substituted, it is recommended that substitution is performed with at least one kind of elements other than alkali metal elements, for example, transition metal elements such as Co, Ni, V, Fe, Ti, Cr, Cu and so on, alkali earth metal elements such as Mg, Ca and so on, and elements such as Al, In, Ga, B, Si and so on.

As well as the utilization of conducting the above mentioned lithium manganese as an active material on a positive electrode, other active materials may be mixed or such additives as transition metal compounds may be added. It is preferable for the invention to use lithium manganese as a main component. When a transition metal compound is used as an additive, the mass ratio employed is recommended to be in the range of 0.005 to 0.03 per 1 Mn, and moreover, Co or Ni compound additive is preferable.

Furthermore, in the view of improvement of the high rate discharge characteristics of batteries, it is preferable to hold the weight of positive mixture application below 1.6 g/100 cm² (per one side). This makes the area of electrode larger and allows the current density to be lower. It is also preferable to hold the average particle diameter of the positive active material below 30 μm. This makes smaller the particles in the active material and larger the surface area of active material contributing to electrode reactions and reduces the interface resistance. In addition, it is preferable to hold the BET specific surface area of the positive active material larger than 0.1 mm²/g. This makes smaller the particles in the active material and larger the surface area of the active material contributing to electrode reactions and reduces the interface resistance.

As a conductive material, it is possible to use carbon compounds including, for example, natural graphite, artificial graphite, carbon black such as channel black, acetylene black, ketjen black and furnace black, and carbon fiber. As a binder, the agent refractory to electrolyte solution including poly vinylindene fluoride, polyamide resin, polytetrafluoroethylene (PTFE), styrene butadiene rubber, fluoro rubber, and the like can be used. As a solvent, N-methyl-2-pyrrolidone and the like can be used. When the mixture in which such a conductive material, a binder and a solvent are added is used as an application paste, the preferable composition (mass ratio) is, for example, a conductive material of 1 to 10, a binder of 2 to 20, and a solvent of 30 to 300 against an active material of 100.

As a substrate, it is possible to use metal foils such as aluminum, copper, nickel and stainless steel, inorganic oxides, organic polymer materials, and conductive films such as carbon or metal-deposited films (including, for example, polyethylene terephthalate, polyamide and polyphenylene-sulfide as base films and gold, copper, aluminum and so on as deposited films). As for the form of such conductive base materials, various types of forms are available including a continuous sheet, a perforated sheet, a meshed sheet and so on. It is especially preferable to use a continuous sheet. Furthermore, the application of an active material in the mixture layer may be conducted at one side of the substrate; however, both-side application is preferable.

As a negative active material to be used in the invention, carbon materials are preferable. Carbon materials are broadly classified into two categories: the graphite system having high degree of crystallinity and the non-graphite system having low degree of crystallinity and disordered crystalline structure. The former includes natural graphite and artificial graphite, and although the crystalline structure is disordered, the latter includes the graphitizing carbon (soft carbon) liable to form graphite by the application of heat at 2000 to 3000° C. and non-graphitizing carbon (hard carbon) less liable to form graphite. In the present invention, especially considering the energy density of the battery, it is preferable to use the graphite carbon materials having high degree of crystallinity.

A negative mixed agent in which a carbon material is used as a negative material, usually, comprises a carbon material and a binder which is also used for the positive electrode. When such a mixed agent is formed into paste, the preferable mass ratio is, for example, a binder of 2 to 20 and a solvent of 30 to 300 against a carbon material of 100.

As a separator, it is possible to use micro porous film (made of, for example, polyethylene or polypropylene) separators; organic polymer electrolytes (gelled electrolytes which are made by impregnating, for example, a complex comprising polyether such as polyethylene oxide (PEO) and alkali metal salt, and an organic polymer such as polyvinylidene fluoride, polyacrylonitrile (PAN) and the like with electrolyte solution); inorganic solid-state electrolytes and so on. Not only a sheet form but also a different type in which an electrolyte is directly applied on the surface of the positive and negative electrode sheets can be used.

As a non-aqueous electrolyte, it is possible to use an electrolyte prepared by dissolving various lithium salts, such as, for example, LiClO₄, LiBF₄, LiPF₆, LiCF₃SO₃, LiCF₃CO₂, LiAsF₆, and so on, in a mixed solvent of at least two of aprotic organic solvents, such as, for example, propylene carbonate, ethylene carbonate, dimethyl carbonate, diethyl carbonate, γ-butyrolactone, 1,2-dimethoxyethane, tetrahydrofuran, and so on.

The battery of the invention comprises the above components, and for example, by adopting the flatly wound, spiral structure which is configured by winding positive and negative electrodes, each of which is formed into a strip shape, with a separator therebetween, the battery constitutes a preferred configuration.

A strip electrode is formed by applying an electrode mixture in paste form to the surface of a copper/aluminum metal foil substrate sheet using the reverse roll method or the doctor blade method, by treating the substrate with hot-air drying or vacuum drying, and then by uniformly pressurizing and compressing it using a roll press machine. The strip positive and negative electrodes prepared in this manner are laminated each other with the separator therebetween, flatly wound around the core material to form the generating element, and housed in a cell case.

### Preparation of Test Batteries

Hereinafter, the present invention will be described in detail in accordance with the preferred embodiments.

The non-aqueous electrolyte secondary battery was prepared in the same manner as shown in FIG. 1. The flatly wound type power generating element of the non-aqueous electrolyte secondary battery is so configured that the strip negative and positive electrodes are flatly wound with the separator therebetween and that one edge portion of the negative substrate and one edge portion of the positive substrate protrude from the separator to the opposite direction from each other.

LiMni_{1.95}Al_{0.05}O₄ (when part of Mn is substituted with Al, it is preferable to adopt a mass ratio of 5 to 7%) as a positive active material, acetylene black as a conductive material, and poly vinylindene fluoride (PVdF) as a binder were mixed together in a mass ratio of 91:3:6%, respectively, to obtain a positive mixture. N-methyl-2-pyrrolidone was added as a solvent in this positive mixture, and through the mixing/dispersion process, slurry mixture was prepared. The positive mixture in slurry form was then uniformly applied to a strip aluminum foil having a thickness of 20 μm and a width of 140 mm which was placed on a positive substrate. The same treatment was given on the other side of the positive substrate. A weight of the mixed agent of positive active material applied on a positive mixture layer 8 was 2.5 g/100 cm² per one side of the substrate. After the positive electrode was dried, the thickness of the positive electrode was adjusted using a roll press machine so as to prepare a strip positive electrode 2. A non-applied portion of positive mixture in positive substrate 7 of a width of 10 mm was left at an upper edge portion of the strip positive electrode 2 to dispose a collector.

Graphite powder with which the doping/undoping of lithium is possible as a negative active material and PVdF as a binder were mixed together in a mass ratio of 90:10%, respectively, to obtain a negative mixture. N-methyl-2-pyrrolidone was added as a solvent in this negative mixture, and through the kneading process, slurry mixture was prepared. The negative mixture in slurry form was then uniformly applied to a strip copper foil having a thickness of 10 μm and a width of 140 mm which was placed on a negative substrate. The same treatment was given on the other side of the negative substrate. After the negative electrode was dried, the thickness of the negative electrode was adjusted using the above mentioned roll press machine so as to prepare a strip negative electrode 3. A non-applied portion of negative mixture in negative substrate 9 of a width of 10 mm was left at an upper edge portion of the strip negative electrode 3 in the same manner as the positive electrode.

The strip positive electrode 2 and the strip negative electrode 3 prepared in this manner were spirally wound around a flat center core made of polyamide resin with a separator 4 therebetween to form the flatly wound type generating element 21. In this flatly wound type generating element 21, the length of minor axis (X) was 30 mm, the length of major axis (Y) was 150 mm, and the height (Z) was 150 mm. Arc portions of the power generating element 21 were formed based on a semicircular whose diameter is the length of minor axis. This configuration allows the length of the linear portion on the non-applied portion of mixture layer to be as long as 120 mm. The non-applied portion of mixed layer is on one edge portion of a substrate which protrudes from the upper or the lower of the power generating element, and available to be used for the place where a positive collector 5 or a negative collector 6 is to be disposed.

The positive collector 5 and the negative collector 6, which were made of the same material as the substrates and which had the same length as the linear portion, were disposed, respectively, on the linear portions on the non-applied portions of positive and negative mixture layers, 7 and 9. The non-applied portion of positive mixture layer 7 on the strip positive electrode 2 and the non-applied portion of negative mixture layer 9 on the strip negative electrode 3 were fixed to the positive collector 5 and the negative collector 6, respectively by ultrasonic welding.

The power generating element 21 was then housed into a cell case 1 having a longitudinal length of 33 mm, a width of 167 mm, and a height of 180 mm. The positive collector 5 and the negative collector 6 were connected, respectively, to a positive terminal 11 and a negative terminal 12 disposed on a cover plate 13. Then the cover plate 13 was fit into the cell case 1 and fixed by laser welding.

Next, an electrolyte solution was prepared by dissolving 1 mol/1 of lithium hexafluorophosphate (LiPF₆) in a mixed solution of ethylene carbonate and dimethyl carbonate (in the ratio of the volume is 1:1), and this electrolyte solution was poured into the cell case under reduced pressure. This electrolyte was used in configuring the battery having a symbol A. The capacity at the one hour rate discharge (1C) of the battery A was 35 Ah.

A total of 12 types of batteries were prepared in the same manner as the above described battery A, except for the two dimensions of the flat, wound type generating element. With the length of minor axis (X) kept constant at 30 mm, the length of major axis (Y) and, by extending the width of the strip electrode to be used, the height (Z) were varied. For the substrates of the batteries in which the lengths of major axis were varied, for the purpose of holding the area of collector portion as wide as possible, substrates were so used as to be the same extent as the linear portion of every generating element in this case. And an extent of a non-applied portion of mixture layer of a strip electrode used for each battery was set to 10 mm in every case. The details of the batteries prepared are shown in Table 1 below.

TABLE 1

| | | | Linear | | | |
|---|---|---|---|---|---|---|
| | | | length of | | | |
| | | Length | non-applied | | | |
| | | of major | portion of | | | |
| | Capacity | axis | mixture | | Height Z | |
| Battery | (Ah) | (mm) | layer (mm) | Y/X | (mm) | Y/Z |
| A | 35 | 150 | 120 | 5.0 | 150 | 1.0 |
| B-1 | 21 | 120 | 90 | 4.0 | 120 | 1.0 |
| B-2 | 28 | 120 | 90 | 4.0 | 150 | 0.8 |
| B-3 | 39 | 120 | 90 | 4.0 | 200 | 0.6 |
| B-4 | 48 | 120 | 90 | 4.0 | 240 | 0.5 |
| C | 10 | 90 | 60 | 3.0 | 90 | 1.0 |
| D-1 | 6.0 | 75 | 45 | 2.5 | 75 | 1.0 |
| D-2 | 4.5 | 75 | 45 | 2.5 | 94 | 0.8 |
| D-3 | 5.0 | 75 | 45 | 2.5 | 125 | 0.6 |
| D-4 | 7.5 | 75 | 45 | 2.5 | 150 | 0.5 |
| E | 9.5 | 60 | 30 | 2.0 | 60 | 1.0 |
| F | 3.0 | 45 | 15 | 1.5 | 45 | 1.0 |

(Charge/Discharge Test)

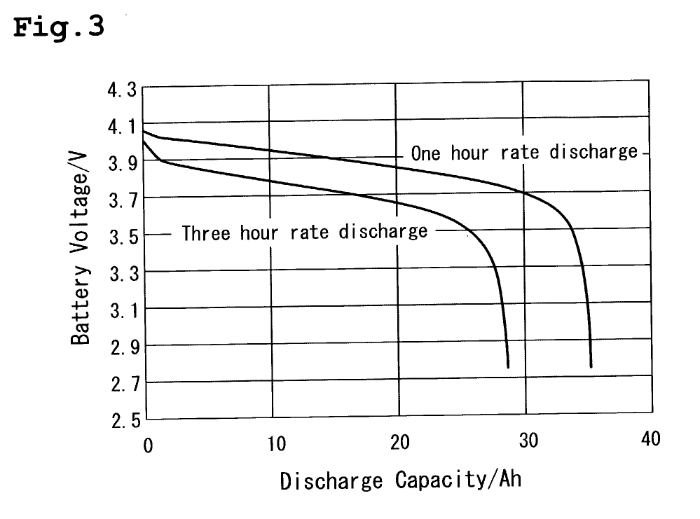

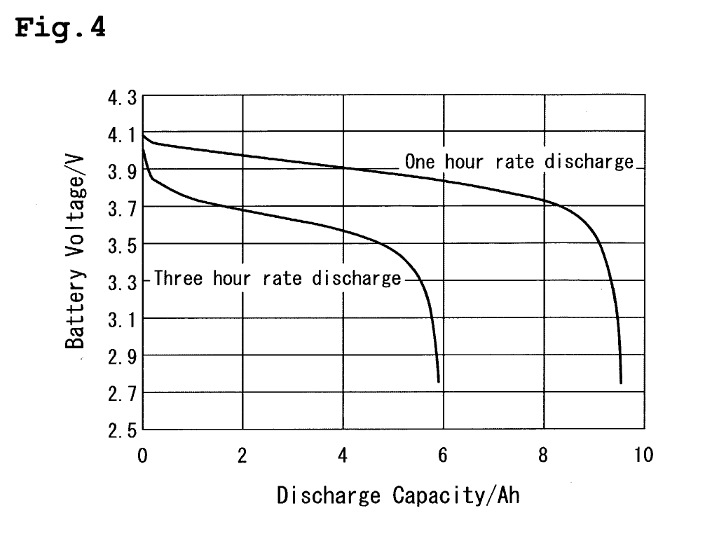

In order to compare high rate discharge characteristics of the batteries prepared in the above manner, at a temperature of 25° C., these batteries were charged for a total of 3 hours, first at a constant current of the one hour rate (1C) until the voltages rise up to 4.1 V and then at a constant voltage of 4.1 V. After a 10-minute intermission, they were discharged at a constant current of the one hour rate (1C) until the voltages drop to 2.75 V. Thereafter, following the charge in the same conditions as the above mentioned, they were discharged at a constant current of the three hour rate (3C) until the voltages drop to 2.75 V. FIGS. 3 and 4 show, as representative examples, discharge curves of the one hour rate discharge and the three hour rate discharge of batteries A and E, respectively.

In addition, in order to measure temperatures of collectors during discharge, thermoelectric couples were fixed to the positive and negative terminals, each of which was directly connected to the positive or negative collector, and then temperature changes during discharge were measured.

Table 2 shows the obtained discharge capacity at the three hour rate (3C) discharge divided by the obtained discharge capacity at the one hour rate (1C) discharge, that is, capacity retention (%) at the three hour rate (3C) discharge, and the maximum temperatures reached of the positive and negative terminal portions during discharge. These data were based on the average of the results on five test batteries.

TABLE 2

| | | | Capacity | Maximum temperature | |
|---|---|---|---|---|---|
| | Discharge capacity (Ah) | | retention at | (° C.) | |
| | 1C | 3C | 3C discharge | Positive | Negative |
| Battery | discharge | discharge | (%) | terminal | terminal |
| A | 35 | 30.8 | 88 | 34 | 33 |
| B-1 | 21 | 17.0 | 81 | 33 | 32 |
| B-2 | 28 | 21.6 | 77 | 34 | 33 |
| B-3 | 39 | 28.5 | 73 | 32 | 31 |
| B-4 | 48 | 30.7 | 64 | 32 | 32 |
| C | 10 | 7.8 | 78 | 31 | 30 |
| D-1 | 6.0 | 4.3 | 71 | 36 | 36 |
| D-2 | 4.5 | 3.1 | 68 | 38 | 39 |
| D-3 | 5.0 | 3.1 | 61 | 40 | 40 |
| D-4 | 7.5 | 3.9 | 52 | 43 | 44 |
| E | 9.5 | 5.9 | 62 | 51 | 50 |
| F | 3.0 | 1.3 | 43 | 63 | 64 |

(Relationship between Y/X and Maximum Temperature Reached)

In accordance with Table 2, the relationship between Y/X, the ratio of the length of major axis, Y, to that of minor axis, X, and the maximum temperatures reached at the positive and negative terminals was studied. As for the maximum temperatures, the batteries A to D-4 reached lower than 44° C., while the batteries E and F reached higher than 50° C. As for the discharge curves, it was noted that the polarization in the battery E (FIG. 4) was remarkably larger than that in the battery A (FIG. 3).

According to these results, in the batteries E and F which show a significant rise in temperature at the terminal portions, the values of Y/X were smaller than 2.0, which means that the lengths of the linear portions in the non-applied portions of mixture layers in the strip electrodes which can be used for current collection were short, so that it is believed the cross-sectional areas of the collector portions became smaller than those of other batteries and that the resistance in the collection portions became higher. This assumption is based on the fact that the polarizations at the three hour rate discharge in the batteries E and F were remarkably larger than those in other batteries. These test results revealed that it is necessary that Y/X, the ratio of the length of major axis, Y, to that of minor axis, X, be larger than 2.5 to satisfactorily hold high rate discharge characteristics. Furthermore, it is preferable to make the ratio of Y/X larger than 3.0 in order to secure much more sufficient high rate discharge characteristics. (Relationship between Y/Z and the Capacity Retention at the Three Hour Rate Discharge)

Next, the relationship between Y/Z, the ratio of the length of major axis, Y, to the height, Z, and the capacity retention at the three hour rate (3C) discharge was studied.

The batteries B-1, B-2, and B-3 which have the Y/Z values of larger than 0.6 had larger capacity retentions at the three hour rate (3C) discharge than that of B-4 which has the Y/Z values of smaller than 0.5. In the same way, the batteries D-1, D-2 and D-3 had larger capacity retentions at 3C discharge than that of D-4.

In addition, the Y/Z values in the batteries E and F were 1.0; however, since the values of Y/X were smaller than 0.2, the capacity retentions at the three hour rate (3C) discharge became considerably small, too.

According to these results, when the value of Y/Z was smaller than 0.6, which means that the height of the generating element, Z, was much greater than the length of major axis, Y, the distance from the collector portion to the end of the generating element became long, and therefore, it is believed that this caused the current density of the electrode at discharge to be non-uniform and then resulted in a decrease in the capacity performance of the generating element.

The value of Y/X represents a numerical value indicating the degree of flatness of the generating element, and the flatter the generating element is, the larger the cross-sectional area of the collector becomes. Therefore, it works as an effective parameter for the non-aqueous electrolyte secondary battery having high rate discharge characteristics. In the above tests, the batteries having the Y/X values of larger than 5.0 were not evaluated but the Y/X values still remain effective even when they exceed 5.0. However, when the generating element is formed into an excessively flat shape, the portion occupied by the center core becomes relatively large in the battery configuration, so that an energy density could tend to be lowered. Thus, practically, the range of Y/X≦7.0 is desirable, and further the range of Y/X≦5.0 is more desirable.

In addition, when the height of the generating element is lower, a current density at high rate discharge is less likely to be non-uniformity; therefore, regarding the Y/Z value, the larger the better. In the above tests, although the batteries having the Y/Z values of larger than 1.0 were not evaluated, the Y/Z values still remain effective even when they exceed 1.0. However, when the height of the generating element is too low, the portion occupied by the non-applied portion of mixture becomes relatively large in the electrode, so that an energy density could tend to be lowered. Thus, practically, the range of 0.6≦Y/Z≦1.2 is desirable.

Furthermore, in the embodiments above described, the positive and negative substrates were formed by an aluminum foil with a thickness of 20 μm and a copper foil with a thickness of 10 μm, respectively. In response to the demands for batteries of lighter weight, however, even thicker substrates are likely to be utilized for non-aqueous electrolyte secondary batteries having large discharge capacity of 3 Ah or more. In a substrate with a reduced thickness, especially the cross-sectional area of the portion to which a collector is connected and fixed will be narrowed, high rate discharge characteristics will be affected, and the temperature of the area will rise. Hence, to prevent such problems from occurring, it is required to take measures so as to make thicker the portion of collector to which the substrate is connected. However, when the thickness of the collector is increased, there arises a disadvantage that a welding power becomes less strong when ultrasonic welding is performed between the collector and the substrate. This causes percent defective in the course of battery manufacturing to increase and thus there exist necessary limitations in either case. In consideration of these points, appropriate thicknesses of an aluminum foil on the positive substrate and a copper foil on the negative substrate fall within the ranges of 10 to 20 μm and 5 to 10 μm, respectively.

As described previously, a non-aqueous electrolyte secondary battery in which a flat, wound type power generating element is so configured that strip negative and positive electrodes are flatly wound with a separator therebetween and that one edge portion of a negative substrate and one edge portion of a positive substrate protrude from the separator to the opposite direction from each other can provide excellent high rate discharge characteristics when the dimensions of said flat, wound type power generating element hold the relations of Y/X≧2.5 and Y/Z≧0.6, where X is the length of minor axis, Y is the length of major axis and Z is the height of said flat, wound type power generating element held in a cell case.

What we claim is:

1. A non-aqueous electrolyte secondary battery comprising:
a strip negative electrode having negative mixture layers on a negative substrate:
a strip positive electrode having positive mixture layers on a positive substrate;
a separator;
a cell case housing a power generating element in which said strip negative and positive electrodes are wound elliptic-cylindrically with said separator therebetween; and
a cover plate fitted on the opening of said cell case;
wherein the dimensions of said power generating element satisfy the relations of Y/X≧2.5 and Y/Z>0.6, where X is the length in the direction of minor axis of elliptical section, Y is the length in the major axis direction and Z is the length in the winding axis direction of said power generating element held in said cell case.

2. The non-aqueous electrolyte secondary battery according to claim 1, the dimensions of said power generating element satisfy the relation of Y/X≧3.0.

3. The non-aqueous electrolyte secondary battery according to claim 1, further comprising:
a positive terminal insulatingly disposed on said cover plate;
a positive collector in one end of which is connected to said positive terminal;
a negative terminal insulatingly disposed on said cover plate; and
a negative collector in one end of which is connected to said negative terminal;
wherein one edge portion of said positive substrate and one edge portion of said negative substrate protrude from said separator to the opposite direction from each other,
said positive collector is connected with a linear portion in said edge portion of said positive substrate, and said negative collector is connected with a linear portion in said edge portion of said negative substrate.

4. The non-aqueous electrolyte secondary battery according to claim 1,
said non-aqueous electrolyte secondary battery has a capacity of 3 Ah or more.

5. The non-aqueous electrolyte secondary battery according to claim 1,
said positive mixture layers contains lithium manganese oxide as a positive.

6. The non-aqueous electrolyte secondary battery according to claim 1,
said positive substrate is an aluminum foil having the thickness in the range of 10 μm to 20 μm.

7. The non-aqueous electrolyte secondary battery according to claim 1,
said negative substrate is an copper foil having the thickness in the range of 5 μm to 10 μm.
